(19) United States
(12) Patent Application Publication
(10) Pub. No.: US 2004/0123307 A1
(43) Pub. Date: Jun. 24, 2004

(54) Programming interfaces for an exchange centre

(76) Inventors: Stefan Unger, Unterhaching (DE); Renate Zygan-Maus, Munchen (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/733,745

(22) Filed: Dec. 11, 2003

(30) Foreign Application Priority Data
Jun. 13, 2001 (DE) 10128726.7

(51) Int. Cl. H04M 7/00

(52) U.S. Cl. 719/328; 379/221.06

(57) ABSTRACT

According to the invention, a conventional exchange centre is completed by an additional platform based on commercial hardware and software, whereon special modules whose functions can be controlled externally via open application programming interfaces (API) are implemented. Said platform also enables the development of added valued telephone services by the operators in a commercial software environment based on APIs for exchange centre functions.

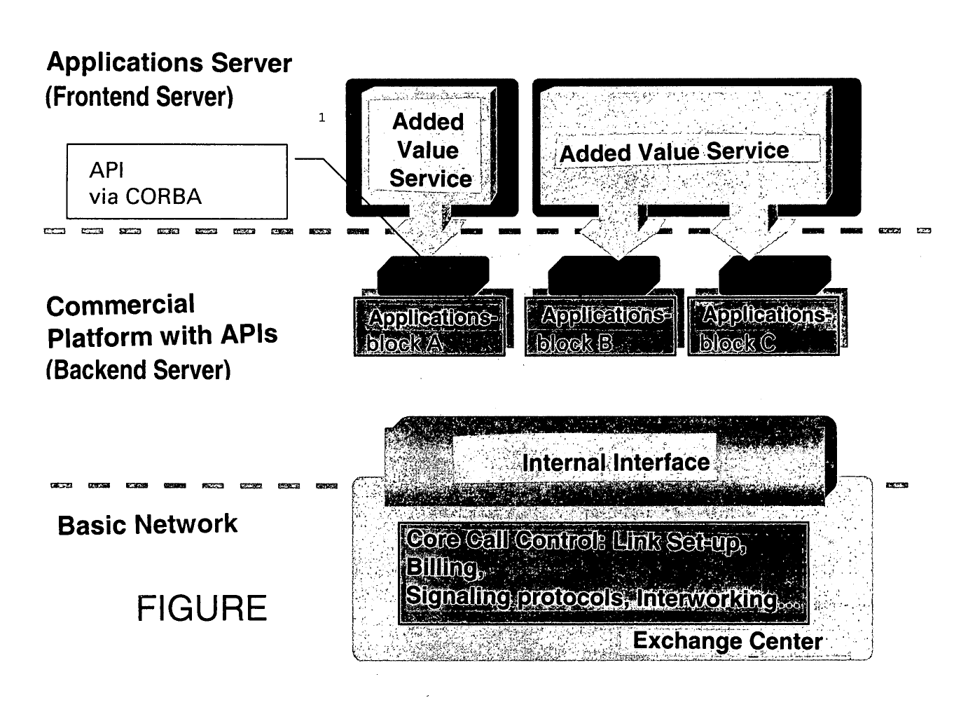

1. What Technical Problem is Resolved by the Invention?

Exchange centres in telephone networks are typically closed systems, meaning that both the realization of the functions supported, such as call setup, billing, statistics, and also the hardware on which the system is based, are proprietary. Operators of telecommunications networks must thus agree their specific requirements for exchange centre functions with the manufacturers who then implement these requirements at their behest.

Network operators are therefore increasingly demanding that the telecommunications equipment manufacturers both use commercial platforms as a basis for their exchanges and also open up the functions on these platforms to “outside” control, i.e. the network operators themselves or programmers commissioned by them should be able to control or expand the functions themselves using the appropriate interfaces.

One of the main reasons behind this demand for openness is the pressure of competition between network operators in liberalized networks. The network operators is thus trying to differentiate themselves from each other by offering new, attractive added value services. It is important in such cases to be able to introduce new added value services rapidly. The network operators are thus demanding open interfaces which will enable them to implement added value services themselves.

2. How has Said Problem Been Resolved Thus Far?

As mentioned above, exchange systems were previously closed systems, i.e. open APIs are not available. The telecommunications equipment companies have developed new exchange centre services and custom developments commissioned by a network operator have only been possible to a limited extent for economic reasons. In addition many exchanges support a standardized SS7 protocol interface to external IN systems for control of services (INAP—Intelligent Network Application Protocol). A Service Creation Environment is offered by many IN manufacturers for these IN systems which allows network operators themselves or SW companies commissioned by them to create IN service programs. IN Service Creation systems have not penetrated the market to any extent. One of the major reasons for this is seen as the complexity of the service programming experienced when using these systems.

Recently efforts have been made to standardize Application Programming Interfaces (APIs) for telecommunications applications in addition to the standardized INAP protocol and other standardized protocols in public telecommunications networks. Initially in industry interest groups, e.g. PARLAY, JAIN, and now also in international standardization bodies such as 3GPP, ETSI and ITU-T.

These standardized APIs map the functionality of underlying protocols as a programming interface. The question of the extent to which the use of these APIs will penetrate the market remains open.

3. In What Way Does Your Invention Resolve the Specified Technical Problem?

In accordance with the invention a classical exchange centre is expanded by an additional platform based on commercial hardware (HW) and software (SW), e.g. The standard operating system UNIX on which special modules (application blocks) will be implemented, for which the functions can be controlled externally via open APIs. This platform thus allows network operators to develop added value telephone services of their own in a commercial SW environment based on Application program Interfaces (API) for exchange functions. Exchange centre and commercial platform communicate via an internal interface which is not standardized and for which the functionality is governed by the requirements of the SW modules to be supported on the commercial platform. Different applications can be implemented on the commercial platform: Protocol conversion applications which the standardized APIs can offer can and other applications that non-standardized APIs can offer.

One difference and advantage of the method in accordance with the invention compared to existing IN SCEs and other systems which only have standardized protocol interfaces available to the exchange lies in the opportunity of having basically free access to all exchange functions via the internal interface between commercial platform and exchange and of being able to use this for implementing applications in accordance with the invention on the commercial platform.

A second difference between the method in accordance with the invention and existing IN SCEs and other systems that only provide standardized APIs lies in the idea of making non-standardized APIs available for higher-value service functionality, such as for example automatic setup of a connection between two PSTN subscribers, automatic setup of a telephone conference between a number of subscribers, booking an automatic telephone conference for a particular time.

Each of these service application blocks has access via the internal interface to the call processing functions of the exchange. The definition of the basic function of a service application block is fixed, for example Setting up a connection in the PSTN between subscribers who can be reached via an E.164 address, including creation of a greetings announcement or initialization of toll tickets for each subscriber in the exchange.

For each service application block open APIs allow the activation of the relevant service functions as well as control of individual service features. For example, for the service application block “Automatic setup of a connection between two PSTN subscribers” it could be possible to explicitly control which of the two subscribers accepts the charges, whether a standard announcement or a personal announcement is to be played as a greeting (requires transmission of the address and identification of the personal announcement) or whether status information about the connection is to be returned via the API (e.g. subscriber busy)

The method in accordance with the invention thus includes the approach of not directly opening up the call processing functions of an exchange centre to the outside via APIs, but of initially defining service application blocks on the commercial platform belonging to the exchange centre, in which the service-specific interworking with the existing network functions is resolved and of which the functions can be controlled via open APIs. Network operators can activate and combine these service application blocks in any way that they wish and thus create new added value services. In this case the actual service logic of the added value service created by the network operator can be located on any server in the network. The service application blocks with their defined APIs are used by the network operator in this case as components for implementing their own added value services (see exemplary embodiment under 5.)

The interworking of the service application blocks is supported by what is known as a Session Manager application block. All application blocks which process active service requests via their API perform a registration for each active service user in the Session Manager. The Session Manager provides an internal API for this purpose. If a service request is ended a deregistration is undertaken. The Session Manager thus has a current map of all active service requests in each case. Their data can be read by each application and thus supports interworking between different service application blocks.

A major advantage of this method is that the users of the APIs to service application blocks do not have to have any detailed knowledge about existing network functions. In particular all details of the relevant signaling system of the basic network are fully transparent at the API user level and the internal interplay between exchange and service application block covers all possible cases of interworking. This method allows the definition of robust and easy-to handle APIs, since the defined scope of each service application block or API restricts possible error cases and can be tested out by the manufacturer.

By contrast with the APIs to higher-value service application blocks in accordance with the invention, the standardized APIs (PARLAY, JAIN, 3GPP, etc.) are based on the approach of mapping protocol functions. These APIs are very complex and require the transmission or control of a very large amount of control information. The implementation of added value services on the basis of these APIs requires expert knowledge of telecommunications.

By expanding a classical exchange centre architecture with a commercial platform, via which APIs are provided for the exchange centre functions it is more easily possible to realize the APIs on the basis of state-of-the-art, object-oriented SW technologies such as CORBA, JAVA RMI or DCOM. Current exchange centres are often based on older SW technologies (e.g. CHILL, ASSEMBLER) which make it more difficult to open the system up via object-oriented-based APIs. by designing non-standardized open APIs to higher-value service application blocks on this commercial platform the circle of potential users of telecommunications APIs is extended to people without any detailed knowledge of telecommunications network functions.

The invention is explained again below with reference to the drawing, which comprises one FIGURE.

The FIGURE shows the principle subdivision of functions between the exchange centre with integrated commercial platform offering open APIs (backend server) and the external application servers that use these APIs (frontend server).

The commercial platform contains a number of application blocks for which a fixed functional scope is defined that can be controlled via open APIs. The functions of the application blocks use the core call control functions of the subordinate exchange centre via an internal interface.

The added value services of the network operators are implemented on separate application servers in the network. In this case the open APIs use the commercial platform to initiate actions in the basic network (e.g. setting up a connection between two subscribers) or to be informed about events in the basic network (e.g. subscriber busy, incoming call). The open APIs are used on the basis of CORBA—which means that the implementation of the SW of the application servers as well as its HW is independent of the SW and HW of the commercial platform.

Abbreviations/References:

| | |
|---|---|
| API | Application program Interface |
| CORBA | Common Object Request Broker Architecture |
| DCOM | Distributed Component Object Model |
| IN | Intelligent Networks |
| INAP | Intelligent Network Application Protocol |
| | (standardized with ETSI and ITU-T) |
| JAIN | Industry consortium (led by SUN): |
| | www.java.sun.com/products/jain/ |
| PARLAY | Industry consortium: www.parlay.org |
| PSTN | Public Switching Telecommunication Network |
| RMI | Remote Message Invocation |
| SCE | Service Creation Environment |

1. Exchange centre with
an additional platform, based on commercial HW and SW and containing one or more SW modules that provide external computers with applications with specific functions via open interfaces (API), in which case said SW modules, for execution of said functions, use internal interfaces to the call control functions of the exchange centre.

2. Exchange centre according to claim 1, characterized in that said open interfaces are realized on the basis of an object-oriented SW technology.

3. Exchange according to claim 1 or 2, characterized in that said open interfaces can also be used locally by applications on the commercial platform to make use of functions of other applications.

4. Exchange according to one of claims 1 to 3, characterized in that a dedicated SW module supports the interworking of said applications on the commercial platform. The interworking SW module provides a platform-internal interface for this purpose.

5. Exchange according to one of claims 1 to 4, characterized in that the said applications involve protocol conversion applications.

6. Exchange according to one of claims 1 to 4, characterized in that the said applications involve applications for a higher-level service functionality.
